(19) United States
(12) Patent Application Publication
(10) Pub. No.: US 2002/0128769 A1
(43) Pub. Date: Sep. 12, 2002

(54) Electronic vehicle monitoring system

(76) Inventors: Viken Der Ghazarian, West Hills, CA (US); Ohanes Der Ghazarian, Henderson, NV (US)

Correspondence Address: OHANES DER GHAZARIAN, 308 GONDOLA WAY, HENDERSON, NV, 89014, US

(21) Appl. No.: 09/859,496

(22) Filed: May 17, 2001

Related U.S. Application Data
(60) Provisional application No. 60/204,979, filed on May 17, 2000.

(51) Int. Cl. G01C 21/26

(52) U.S. Cl. 701/207; 340/988

(57) ABSTRACT

An Electronic Vehicle Monitoring System and Related method for tracking the location of the location of motor vehicles, is disclosed which tracks the location of plurality of motor vehicles at a particular location, to ascertain the exact position at which any motor vehicle is parked. The system of the present invention also automatically determines, when each motor vehicle at a location enters or leaves the location or a particular area. The system of the present invention also automatically determines which of plurality of motor vehicles having a security violation. In addition the system immobilizes the vehicle if tamper to the vehicle mount Transceiver CPU or GPS system is detected, and report said violation to a monitoring station. The system also utilizes an Electronic Key Track

### BACKGROUND OF THE INVENTION

Field of the Invention: The present invention relates generally to systems and methods for tracking the location of motor vehicles, and more particularly to an improved system and method for tracking the location of a plurality of motor vehicles at a particular location or lot to ascertain the exact position at which any motor vehicle is parked, as well as when a motor vehicle enters or leaves the location or lot.

Locations at which a relatively large number of motor vehicles are stored present the problem of determining exactly where each motor vehicle is located, and even whether or not a particular motor vehicles located at a particular location or lot when the business has several different lots. This problem is particularly common to large motor vehicle dealerships, and is equally applicable to automobiles, trucks, recreational vehicles, or other similar motor vehicles. In addition, such businesses must also deal with the theft of motor vehicles, wherein one or more motor vehicle is illegally removed from the location or lot.

A number of different methods have been used in the past to deal with the problem of tracking the location of a large number of motor vehicles at a location or lot. The oldest of these methods is by keeping an inventory register of each motor vehicle and its location, either in a paper journal of some kind or more recently, in a computerized database. Inventory registers depend on each individual who may move a motor vehicle for any reason recording that move, as well as the motor vehicle's new location. Ultimately, this system will not accurately reflect the location of all motor vehicles simply because not all employees at the location will enter each move of a motor vehicle. Similarly, another common system which relies on the placement of the keys of each motor vehicle on a large board in a position reflecting the location of the motor vehicle also requires the full time cooperation of each person at the location or lot, and hence also will not work all of the time due to human nature.

As might be expected, a variety of different approaches have been taken to attempt to solve the problem of monitoring large numbers of motor vehicles at a location or a lot. This approaches vary widely, encompassing both increased security measures and electronic vehicle monitoring. With regard first to increased security measures of particular application to motor vehicles at a location or lot, the measures taken commonly include security fences or compounds, the use of video monitoring of areas in which motor vehicles are stored, the use of motion sensors in such areas, and the use of security guards to patrol such areas. While such approaches may reduce the incidence of theft somewhat, they are not useful in addressing the primary problem contemplated by the present invention, namely how to keep track of the location of a number of motor vehicles located at a particular location or lot.

The electronic security measures mentioned above also vary widely, from the use of electronic cards, to highly complex electronic motor vehicle communication system, to the use of simple electronic motor vehicle tags which may be read as a motor vehicle passes a location having an electronic tag reader.

An example of the use of electronic cards associated with each motor vehicle is illustrated in U.S. Pat. No. 5,459,304 to Eisenmann, which discloses a smart card for containing a variety of information pertaining to a particular motor vehicle. The electronic card approach is not helpful to the situation contemplated herein, since it does not contain information pertaining to the location of a motor vehicle, but rather information about a particular motor vehicle and its owner and operator.

An example of the use of electronic motor vehicle communication system is illustrated in U.S. Pat. No. 5,552,789 to Schuermann, which teaches a highly complex system for performing a variety of functions in the vehicle. The Schuermann system is simply too complex and too expensive to find application in the present situation.

Example of electronic motor vehicle tags which may be read by an electronic tag reader are found in Schuermann, as well as in U.S. Pat. No. 5,311,186 to Utsu et al., U.S. Pat. No.5,635,693 to Benson et al., and U.S. Pat. No. 5,661,473 to Paschal. Schuermann describes the use of a transponder on each motor vehicle, which may be used for premises or toll access. Utsu et al. teaches a communication system between a motor vehicle transponder and a devise for interrogating the transponder. Paschal teaches such a system which may be used to automatically identify stolen motor vehicles. Benson et al. is perhaps the most detailed of such electronic motor vehicle tag/electronic tag reader system, and a brief description of the Benson et al. system is illustrative of both the benefits and the limitation of such systems, as they are currently known. The Benson et al. system attempts to resolve the situation addressed by the present invention by electronic and automatically tracking motor vehicles as they enter and leave a dealership lot. An electronic tag located in each motor vehicle is read whenever that motor vehicle passes an electronic checkpoint at an entrance to or exit from the location or lot. The present invention central monitoring station tracks all the motor vehicles at location as they enter lot leave without the use of electronic entrance checkpoint readers.

While the Benson et al. system is highly useful and represents a significant improvement in the art, it does not address the problem addressed by the present invention, namely maintaining the location of motor vehicles at a location or lot. The Benson et al. system is not capable of determining where on a location or lot each motor vehicle is, but rather only information relating to each motor vehicle entering or leaving a location or lot.

Another example of mobile object tracking system is illustrated in The U.S. Pat. No. 5,631,642 to Brockelsby et al. Which describes an array of signpost stations distributed in a area and a vehicle based become transmitter arranged to transmit a vehicle identification signal and a vehicle location signal driven from the signpost identification signal. The Brockelsby et al. system does not address the problem addressed by the present invention namely maintaining the location on particular motor vehicle at a particular parking space. The Brockelsby et al. System is not capable of determining where on a location or lot each motor vehicle is parked. But rather only information relating to each motor vehicle passing a street comer or a wide area in a town.

Example of a Method for retrieving vehicle collateral U.S. Pat. No. 6,025,774 to Forbes Illustrates Vehicle equipped with GPS antenna receiver and a cellular phone capable transmitting location data regarding the vehicle and monitoring default loan status and establishing a data link from a base terminal to the transmitter of the vehicle upon an occurrence of the default. The transmitter is capable of sensing any physical tampering therewith and transmitting a temper signal in response to any sensed tampering.

The present invention uses a tamper proof GPS receiver and a cellular phone modem or two-way pager, for location identification. In the present invention each one of said vehicle Transceiver unit. GPS antenna/receiver and the GPS base cellular phone unit is equipped with, a pressure sensing tamper switch mounted on the mounting surface side against said vehicle body (windshield) to monitor security violation and location of a particular vehicle at a site. Said vehicle ignition or fuel pump electronic circuitry communicating with an RF or Digital data with said vehicle mount GPS base Phone and Transceiver unit. If an unauthorized attempt is made to tamper or remove any of said units, said vehicle mount GPS based phone and the RF transceiver unit will transmit a signal to interrupt the ignition or fuel pump of said particular vehicle by use of RF communication or digital data link, and Send a security violation tamper signal to a monitoring station.

Forbes system fails to describe the presence of a GPS base phone and Vehicle transceiver unit with a tamper-sensing circuitry which will immobilizes a vehicle starter. Ignition or fuel pump and signals a monitoring station after a tamper-sensing circuitry detects unauthorized removal of a GPS base phone or transceiver unit. There shall for, Forbes “physical tampering detection signal” may be received by a monitoring station. But Forbes system can not locate the vehicle, due to the fact in Forbes teaching, after a vehicle GPS equipment is tamper with, the vehicle is not immobilized. There shall for vehicle could be in motion, and the GPS/phone unit pending on damage severity caused during tamper, the units could be inoperative, and the monitoring station cannot know where a moving vehicle location is. Contrary to the present invention, if and when vehicle RF or GPS/phone units are tampered with. The monitoring station upon receipt of tamper signal from said vehicle unit, it can locate the particular vehicle base on last known vehicle location, due to fact the tampered vehicle is immobilized and last location is known to a monitoring station.

Example of Asset Location System U.S. Pat. No. 6,069,570 to Herring illustrates an Asset Location System, wherein an asset is equipped with a pager receiver. A GPS receiver and a cellular phone, communicating with a monitoring station. When a movable asset is to be located, a call is sent out to an asset equipped with a pager when the pager receives said signal it power-up the GPS antenna and the cellular phone to sent location information to a central station relating to a particular asset.

The present invention teaches, a GPS based phone or two way pager installed in a vehicle and operating in a stand by mode (not being powered-up by a pager signal as Herring) and is equipped with a tamper sensing switch on its mounting side against the vehicle, utilized to immediately notify a monitoring station (contrary to Herring. A pager call is sent) and immobilize vehicle ignition upon said switch detecting unauthorized removal of said GPS antenna. Mobile phone. Two-way pager and vehicle transceiver unit.

Example of Programmable Vehicle Monitoring U.S. Pat. No. 5,986,543 to Johnson, describes a Vehicle security system with intrusion detecting devise connected to a GPS base phone unit. When intrusion takes place said vehicle GPS base phone transmits an intrusion signal to a central monitoring station which will identify and locate said vehicle in addition the monitoring station is capable sending a signal to shut said vehicle ignition or fuel pump and Lock/unlock doors via the mobile phone installed in said vehicle. The intrusion detecting RF transceiver and GPS based phone units used in the present invention is tamper sensing and using pressure sensing switch and it is mounted in a vehicle against the vehicle body or as described in the invention mounted within rear view mirror (camouflaged), a substantial improvement over prior art Johnson system. If the GPS or RF Transceiver or cellular modem units being tampered (disconnected or removed) said vehicle intrusion detecting RF transceiver unit will transmit a RF tamper signal, and GPS based phone unit will transmit a tamper signal to a central monitoring station and in addition will shut down said vehicle ignition or fuel pump, contrary to Johnson, without the need of receiving command from a central monitoring station, and the low power base station RF transceiver sends signals to control particular vehicle door lock and unlock circuitry, and to flash lights or immobilize a particular vehicle engine in a lot without the acquiring cost. In Contrary to Johnson, which teaches a monitoring station sending signals, to immobilize vehicle engine and lock/unlock doors via costly phone service

Example of Car Rental System U.S. Pat. No. 5,289,369 to Hirshberg, describes vehicle and a central control equipped with a computer keyboard and a Monitor, in a car rental system, the user using a card access to operate vehicle mount control system. The system comprises for detecting in a real time the exact location of a rental car while travels through streets of town by means of street intersection post mount transceivers communicating with rental car system to indicate to driver vehicle location and said street transceiver being connected by use of phone line or other mean, communicating to central control unit, indicating to said central control said street transceiver and vehicle location.

The present invention plurality of vehicle transceiver units does not require driver access card, in order to operate vehicle installed transceiver unit. Hirshberg system is not capable of determining where on a parking lot each motor vehicle is parked, but rather only information relating to each motor vehicle passing a street in a town. As such it is an objective of the present invention that it be capable of identifying the particular location of each vehicle at a location in a parking space is performed by use of unidirectional infrared and or electromagnetic communication signals between vehicle transceiver unit and parking space units (with a 6-8 feet range), without interfering the communication between other parking space unit(s) and vehicle transceiver unit(s) located within next to its proximity (approx. 6 feet apart). Since Hirschberg system uses (Omni directional) RF signal to communicate between vehicle and street transceiver unit. If one were to relocate Hirschberg's pole mount transceivers from that of street comer locations, into a plurality of parking space slots (6 feet apart) from each other to communicate with vehicle mount transceiver unit in a lot, using similar method of Hirsch bergs vehicle transceiver unit, for the purpose of plurality of vehicles and plurality of parking space unit to communicate next to each other's proximity, in such a close parking slot. With use of Hirsch berg post mount transceivers and vehicle mount transceivers unit, the communication will definitely interfere each other. The vehicle mount transceiver will not be able to determine one post unit location from the other. There for Hirschberg system cannot operate in a parking lot, and be able to identify a particular vehicle location at a particular parking space, due to signal collision between the vehicles and parking space units. The location identification will definitely be misread. In addition Hirschberg central control system fails to retrieve from a particular vehicle transceiver unit the location of said vehicle, in a particular parking space on a lot.

Example of Vehicle Waiting Time indicator U.S. Pat. No.5,163,000 to Rogers, describes a Vehicle Service station having multiple lanes; each lane has one or more sensors for sensing the presence of vehicles in lane. Each station computer is responsive to the lane sensors for computing the waiting time for vehicle.

The present invention is not used for monitoring vehicles waiting inline to be serviced. The prior art “Roger” invention does not teach having a station computer capable of communicating with a vehicle mount RF transceiver unit and identifying each one of said particular vehicle information parked at a particular parking space.

Example of Hired Vehicle Transportation System U.S. Pat. No. 5,726,885 to Klein et al. Teaches a Hired Vehicle Transportation system wherein plurality of usable vehicles are available for hire with one or more collection and return point. A control center is equipped with automatic collection and return mechanism which issues authorized persons driving authorization for the vehicles parked at the respective collection and returns point in the form of associated vehicle keys and take back again the keys of the vehicle at the end of a journey. The disposition center ascertains the individual availability of vehicles and makes reservation.

The present invention is relatively defers and it is an improvement over “Klein's Automatic Key Collection and return Machine. Herein each one of said Vehicle Key Track Unit (Key Dispenser) is equipped with a computer. A keyboard. A monitor to indicate vehicle information and location on a lot and a user Finger Print Reader and RFID (transponder) Key reader. when a Authorized person put their finger on “key track” finger read scanner, the “Key Track” unit upon reading persons valid (pre-programmed) fingerprint pattern, The Key Track unit signals to the user to enter (through said Keyboard) a selected vehicle ID code (VIN Number) Upon receipt of the selected vehicle ID code The Key Track unit will dispense a particular vehicle key containing RFID Tag to an authorized user, said vehicle Key RFID Tag information will be read by said Key Track Unit, and said Key Track unit will indicate a particular vehicle Key is being check out from its inventory, and memorize in its memory the person ID information which whom took a particular vehicle key at a particular site at a particular Time. When the user dispenses back said vehicle Key in to the “Key Track” unit. The key Track unit Reads The RFID Key Information and logs back in its inventory the presence of a particular vehicle Key, and time stamps in its memory.

In the present invention plurality of said Key Track Units could be installed in different sites. Each one of site Vehicle Key Track Units are interfaced to Each other via a network of computers or by a Web server.

Additionally said Key Track Unit is equipped with a microphone. A voice recognition processor and a speaker used to give verbal instruction to the user. For user identification it utilizes user voice recognition system to dispose a particular vehicle key. In the preferred embodiment of the present invention, user gives verbal commends in order to select a particular vehicle and receive the particular vehicle Keys from said Key Track Unit without the use of a Keyboard.

The present invention teaches a Key Track System in which only authorized personal who's fingerprints and or voice is preprogrammed into said Key Track unit can get access to particular vehicle keys found in a “Key Track” System. Contrary to Klein system is designed to achieve for public hire vehicle transportation system, any one having in their possession a valid access card could get access to particular vehicle key.

It is according the primary objective of the present invention that it provides an electronic vehicle tracking information system which will track the present location of each of a plurality of motor vehicles at a location in a lot, such as for example a motor vehicle dealership. As such it is an objective of the Electronic Vehicle Monitoring System of the present invention that it be capable of identifying the particular location of each motor vehicle at a location in a parking space is performed by use of directional infrared (Ultrasonic) or electromagnetic communication signal between vehicle transceiver unit and parking space units, without interfering the communication between parking space units and vehicle transceiver units located within next to each other proximity. In addition eliminating any possibility of a vehicle transceiver to misread a parking space unit next to of its proximity.

It is a further objective of the Electronic Vehicle Monitoring System of the present invention that it be capable of automatically determine when each motor vehicle at a location or lot entered in to a base station computer interface unit upon vehicle ignition being turned off and the base station computer is capable determining vehicle presence in the lot or at a particular parking space location by signaling a particular vehicle transceiver with a unique code, and the vehicle transmitting a unique coded signal back to base station computer interface unit identifying its presence and location on the lot at a particular parking space.

It is still another objective of the present invention that it be capable of optionally providing additional features in the nature of motor vehicle security system to each vehicle. It is still further objective of the present invention to provide a mechanism whereby information located at a base station can be transmitted to a particular motor vehicle which might include command to start or stop vehicle engine. To arm or disarm the alarm unit or lock and unlock the doors. To exchange information identifying a particular vehicle. Ascertain the location of a particular vehicle location by use of tamper proof GPS receiver unit and able to inventory control plurality of motor vehicle located on a lot. Time stamp vehicle presence and absence and control car Key track (Automated Key dispenser) and additionally to report any security violation to a central monitoring station, by use of a digital or voice “Auto dialer”

Finally, the Electronic Vehicle Monitoring System of the present invention, wherein the vehicle transceiver, and the GPS unit are tamper proof design, if unauthorized attempt is made to tamper with, remove or cut the harness the vehicle ignition or fuel line will be immobilized, the vehicle horn will honk, and the presence of tamper with vehicle mount GPS unit will be reported to a monitoring station via a cellular, UHF, or Satellite modem.

Nevertheless, the Hirschberg system U.S. Pat. No. 5,289,369 as well as the other electronic vehicle tracking systems mentioned above are important and useful background to the present invention. Accordingly, U.S. Pat. No. 5,311,186, to Utsu et al., U.S. Pat. No. 5,552,789, to Schuermann, U.S. Pat. No. 5,635,693, to Benson et al., U.S. Pat. No. 5,661,473, to Paschal, U.S. Pat. No. 5,631,642 to Brockelsby, U.S. Pat. No. 6,025,774 to forbes. U.S. Pat. No. 6,069,570 to Herring. U.S. Pat. No. 5,986,543 to Johnson. U.S. Pat. No. 5,163,000 to Rogers U.S. Pat. No. 5,726,885 to Klein et al. each hereby incorporated herein by reference.

### SUMMARY OF THE INVENTION

The disadvantages and limitations of the background art discussed above are overcome by the present invention. With s invention, interacting electronic components are located in each motor vehicle to be monitored, in each parking slot at a location or lot such as, for example an motor vehicle dealership in which the motor vehicles may be stored, and at a base station from which the Electronic Vehicle Monitoring System of the present invention is to be operated.

A motor vehicle at the motor vehicle dealership contains a vehicle unit which is mounted in the motor vehicle and which includes a low power infrared or electromagnetic transmitter. The signal from the vehicle unit are short range directional so that they can only be received by a parking space unit when the motor vehicle in which the vehicle unit is mounted is parked in the park slot in which the parking space unit is mounted and a transceiver to receive and transmit RF signal which identifies the particular vehicle unit.

Each parking space unit which is located at each parking space in the motor vehicle dealership contains a Infrared or electro magnetic Receiver to receive infrared or electro magnetic signal from a motor vehicle unit parked in at that particular parking slot. A transmitter to transmit a radio frequency (RF) signal which identifies the particular parking space in which the parking space unit is located.

Thus when a motor vehicle is parked in a particular parking slot. Upon vehicle ignition is system is turned off the vehicle unit transmits a infrared or electro magnetic signal, the parking space unit receives the infrared or electro magnetic signal from the vehicle unit. The parking space unit upon receiving the infrared or electro magnetic signal transmits a RF signal identifying the particular parking slot in which the parking space unit is located. Additionally the vehicle unit upon vehicles ignition system being turned off transmits a secondary RF signal identify the particular vehicle unit.

In the present invention, the parking space unit also capable transmitting a RF signal identifying both the particular motor vehicle unit and particular parking space unit. In addition in the present invention plurality of parking slot space units could signal vehicle transceiver units, by means of a motion detector or pressure sensor switch installed in plurality of parking space. When a vehicle enters a particular parking space area, the sensor detects the vehicle movement and signals the parking space unit upon receipt the signal, transmits a RF signal identifying both the particular motor vehicle unit and particular parking space unit.

In a preferred embodiment of the present invention, the base station computer interface unit signals plurality of vehicles unit and the vehicle units signals a particular parking space unit. The parking space unit upon receiving the signal transmits an infrared or electromagnetic signal to a vehicle unit and the vehicle unit signals with an RF signal to a base station unit information containing both the particular vehicle unit and particular parking space unit.

The RF signal from each of the vehicle units and parking space units are provided to a base station transceiver unit which is connected to a computer to store and maintain information relating to the vehicle and its location.

The base station computer is capable of monitoring the presence and location of the vehicles located on the lot periodically at a set time by transmitting a RF signal to the vehicle and parking space units to send a RF signal back to base station unit containing information relating to the presence of particular vehicles and their locations.

In a second additional aspect of the present invention, the base station is capable of monitoring a motor vehicle on a lot without the use of parking space unit. In this aspect the base station computer can give a user information relating particular vehicles presence and absence on a lot for a particular time.

Optionally, additional features may be included in the vehicle unit, for example, a motor vehicle security system may be integrated into the vehicle unit, thus, for example, the vehicle unit may monitor access to the motor vehicle through the use of an ignition switch sensor, a motion sensor, or a door, hood trunk sensors etc. Motor vehicles lights and horn or an alarm siren may also be provided. The vehicle unit in the present invention is capable of signaling the base station unit. The presence of a security violation at least one of security violation taking place. The signal from the vehicle to base station is transmitted by a RF signal. In the present invention, the security violation signal should be transmitted to a base station by means of an auto dialer phone or a pager installed within the vehicle. The base station computer capable of transmitting RF signals containing special data to pre-selective motor vehicles containing a vehicle unit. Such data including commands to immobilize the vehicle engine lock or unlock doors, start the vehicle engine, arm & disarm the vehicle alarm system, and transmit vehicle ID information or control a car key track unit, giving access to vehicle key to authorized individual.

In the present invention plurality or vehicle could be equipped with a GPS antenna and the monitoring station could locate a particular vehicle location and in the event of security violation (such as a stolen vehicle) the base station could monitor the speed of stolen vehicle and shut down the particular vehicles ignition or fuel pump at a safe speed.

Additionally, a remote control may be provided for use purchaser of the vehicle to control the vehicle security system integrated into vehicle unit. In this case the vehicle unit will be of use in determining when the vehicle visits the motor vehicle dealership, for example, for service.

In an alternate embodiment, the parking space units may be hard-wired to the base station instead of using RF for these components to communicate with each other, if desired. It may therefore be seen that the present invention teaches an electronic vehicle monitoring system which will track the present location of each of a plurality, of motor vehicles at a location or lot such as, for example, a motor vehicle dealership. As such, the Electronic Vehicle Monitoring System of the present invention is capable of identifying the particular location of each motor vehicle at the location or lot. The monitoring of motor vehicle location at the location or lot be performed completely automatically by the Electronic Vehicle Monitoring System of the present invention, without requiring any information regarding location or movement of motor vehicles to be manually provided to the system when it is operating.

The Electronic Vehicle Monitoring System of the present invention is capable of automatically determining when each motor vehicle at the location or lot enters or leaves the location or lot without the use of gate units. Optionally the electronic vehicle tracking information system of the present invention is capable of providing additional features in the nature of a motor vehicle security system to each vehicle if desired.

Electronic Vehicle Monitoring system of the present invention is capable of determining when a vehicle transceiver or GPS unit has been tampered with. By the use of tamper proof switch on the mounting side of the vehicle and GPS unit, by sensing removal or tampering of the units from the vehicle. When such violation takes place, both the vehicle transceiver and GPS unit will transmit a signal to the vehicle ignition circuitry to immobilize the vehicle engine, honk the car horn, flash the lights and transmit said security violation signal to a monitor station.

The Electronic Vehicle Monitoring System of the present invention is both durable and of long lasting nature, and it will require little or no maintenance to be provided by the user through out its operation lifetime. The Electronic Vehicle Monitoring System of the present invention is also of relative inexpensive construction to enhance its market appeal and to thereby afford it the broadest possible market. Finally all of the aforesaid advantages and objectives of the Electronic Vehicle Monitoring System of the present invention are achieved without incurring any substantial relative disadvantages.

### BRIEF DESCRIPTION OF THE DRAWINGS

FIG. 1—Is General Block Diagram of Electronic Vehicle Monitoring System.

FIG. 2—Is a Electronic Vehicle Monitoring System, wherein a vehicle transceiver unit initiating a signal to a parking space transceiver unit, and parking space and vehicle transceiver unit communicating with the base computer.

FIG. 3—Is an Electronic Vehicle Monitoring System, wherein Parking space transceiver unit, initiating a signal to a vehicle transceiver unit. The vehicle and the parking space transceiver unit communicating with the base station computer connected to a electronic Key Track system.

FIG. 4—Is an Electronic Vehicle Monitoring System, wherein a vehicle transceiver unit communicating with a parking space transceiver unit. And the vehicle transceiver unit is communicating with the base station computer.

FIG. 5A—Illustrates tamper proof adhesive mount vehicle RF transceiver unit.

FIG. B—Illustrates tamper proof magnet or bracket mount vehicle RF transceiver and GPS based cellular or satellite transceiver unit.

FIG. C—Illustrates side view of FIGS. A and B

FIG. D—Illustrates, tamper proof rear view mirror, in it vehicle RF transceiver and GPS antenna with mobile phone transceiver system.

FIG. 6A—Illustrates, tamper proof vehicle transceiver unit mounted into a vehicle windshield or mirror.

FIG. B—Illustrates, a tamper proof vehicle transceiver with GPS unit mounted on a vehicle with bracket or magnet.

FIG. 7—is the base station computer database.

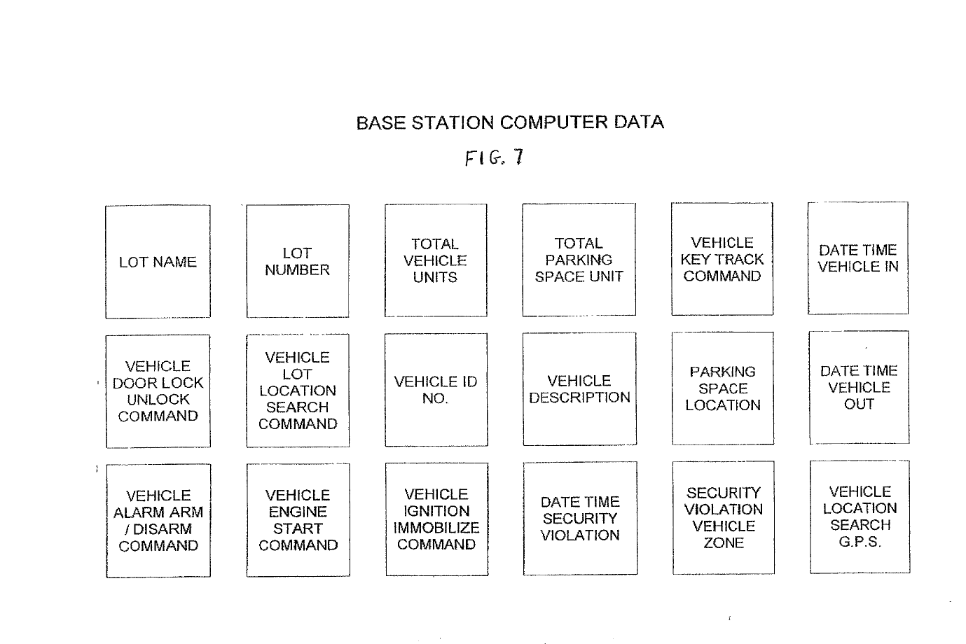

### DETAILED DESCRIPTION OF THE PREFERRED EMBODIMENT

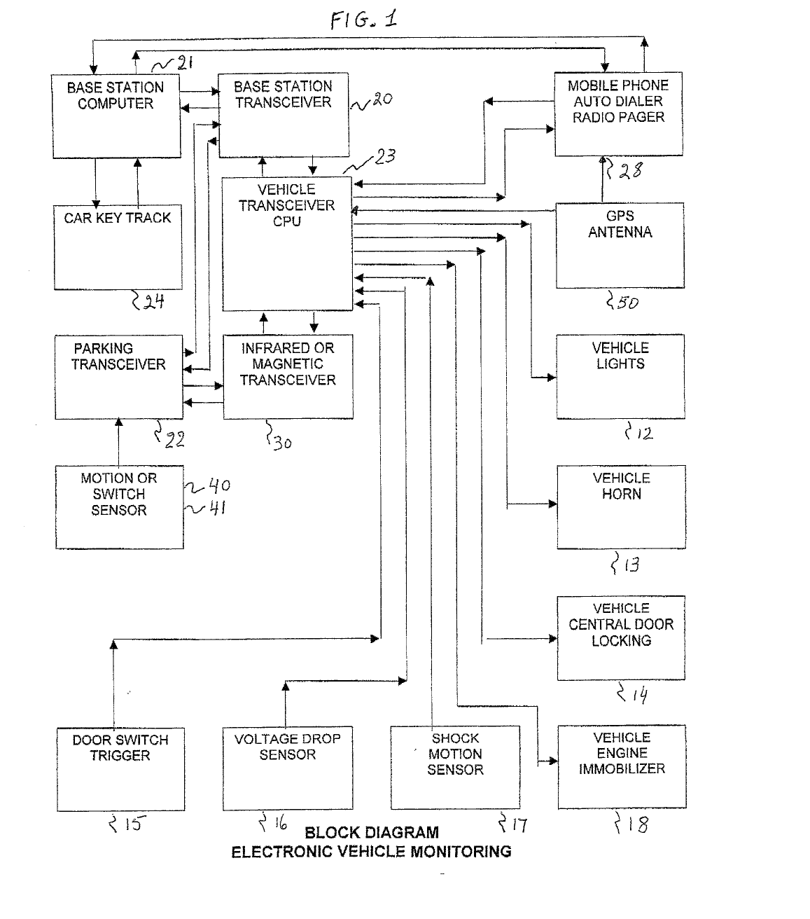

The preferred embodiment of the electronic vehicle monitoring system is illustrated in the FIG. 1—Block diagram. Indicating a base station computer 21, which is the main control center, contains all necessary data to communicate with base station transceiver unit 20. Which, is used to receive data. Log in parking space and vehicle location information, and initiate commands. And to communicate with electronic Car Key Track system 24, to keep all Key Track and user records and provide vehicle location info to said Key track machine 24, which displays the information on the Key Track monitor 29. The base station transceiver 20 communicates with vehicle transceiver unit 23, which sends and receive vehicle and parking space unit data through RF signal. The invention uses a Base station transceiver unit 20, to communicate with parking space transceiver unit 22, by sending a signal to parking space unit 22 and receiving back parking space 22 and vehicle transceiver unit 23 data with an RF or hard wire signal. The communication between the vehicle transceiver unit 23, and the parking space unit 22, is performed through a directional infrared and or RF electromagnetic Transceiver unit 30. In the present invention, the parking space unit 22, could be connected to a motion sensor 40, or a switch sensor 41, to determine the presence of a motor vehicle at a particular parking space, and the sensors 40 and 41 communicating with the parking space transceiver unit 22, to generate a communication link with the vehicle transceiver unit 23, parked in at that particular parking space. The present invention in addition to RF communication, for additional distance coverage and security, utilizes the mobile phone or radio pager unit 28, to receive and transmit data between the base station computer unit 21, and the vehicle transceiver unit 23. In addition a GPS antenna receiver unit 50, is connected to the mobile phone/radio pager unit 28, which transmits vehicle location information to the monitoring station. The GPS antenna unit 50, could be connected directly to vehicle RF transceiver unit 23, in which vehicle location data will be transmitted via a mobile phone/radio pager unit 28 to a base station 21, or vehicle location information could be sent to a monitoring station.

The Electronic Vehicle Monitoring system's vehicle transceiver unit 23 used in the invention, by receiving commands from base station computer 21, is capable of controlling the vehicles lights 12, horn 13, engine immobilization 18, central door locking/unlocking 14, and report an intrusion alarm to a base station computer by use of. Door switch sensor 15, voltage drop sensing circuitry 16, and shock or motion sensor 17 circuitry.

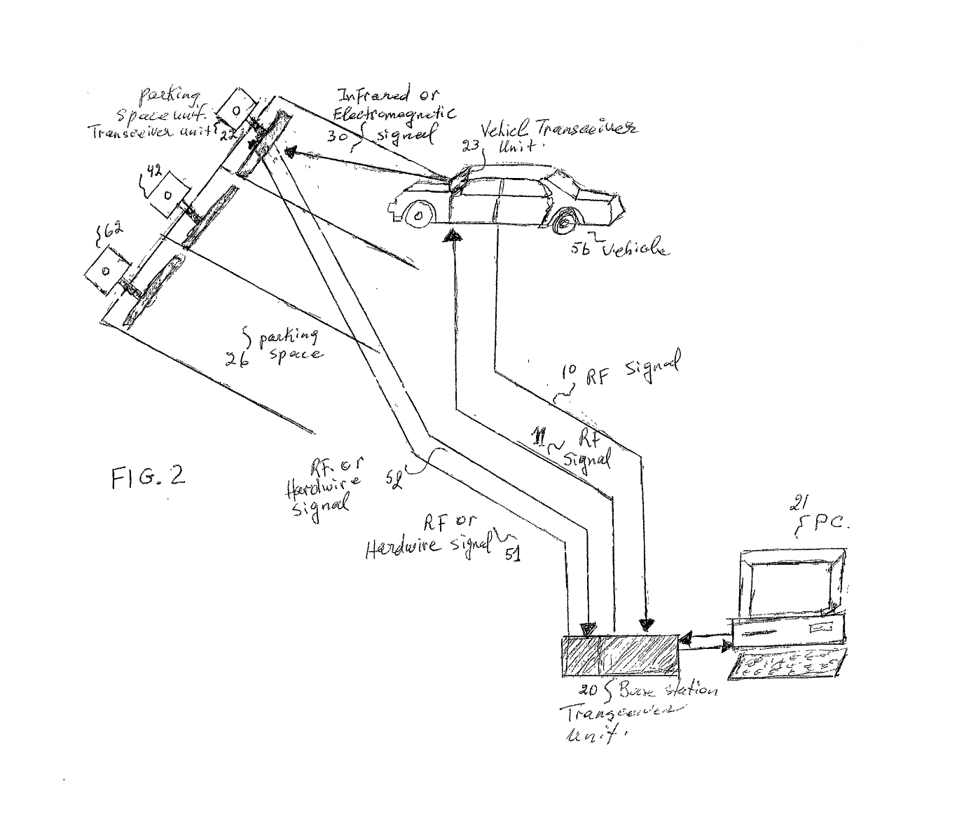

Operation: As shown in FIG. 2 Shows plurality of parking spaces on a lot, having plurality of parking space transceiver units 22, 42, 62. Equipped with infrared or RF electromagnetic receivers, and a low power RF or hardwire transceivers. A vehicle 56, equipped with a unidirectional infrared or electromagnetic transmitter and an RF low power transceiver unit 23, a Base station transceiver 20, interfaced to a computer 21 communicating with said parking space transceiver units and said vehicle transceiver units.

A vehicle 56, equipped with a vehicle transceiver unit 23 signaling with unidirectional short range (6-8 feet) infrared or electromagnetic coded signal 30, to a parking space transceiver unit 22, located on parking space 22, to indicate its presence. And the parking space transceiver unit 22, upon receiving said signal, transmitting through RF or hardwire a coded signal 52, containing information for both particular motor vehicle unit 23 and particular parking space unit 22, to a base station transceiver unit 20, which is interfaced to the base station computer 21, in which logs in its database said particular vehicle 56 presence, time entered, and vehicle info. Along with the particular parking space information that said vehicle 56 is parked in.

The vehicle transceiver unit 23 periodically or at time interval transmitting a signal to said parking space unit 22. And said parking space unit 22 upon receiving said signal, transmitting said particular vehicle unit 23 and parking space transceiver unit 22 information to said base station transceiver unit 20, to update said computer database automatically, with the information relating to the presence of the particular motor vehicle 56 at the particular parking space 22. In the present invention, the base station computer can retrieve a particular vehicle location at a particular parking space in a lot, at any given time, by sending manual or automatic (scan) vehicle location commend signal, through an RF or Hardwire signal 51. If the vehicle 56 departs from the particular parking space 22, the base station computer 21, manual or automatic scan command can not communicate with a vehicle mount transceiver unit 23, the computer database deletes said vehicle 56 from it's database, as vehicle no longer being in the inventory system. If the Base station computer 21 cannot communicate with the vehicle transceiver unit 23, more then 2 intervals, due to vehicle were removed without prior vehicle removal entry into the base station computer database. The base station computer will initiate an alarm signal, and send said security violation signal to a central monitoring station or to a public pager network.

The present electronic vehicle monitoring system is also capable of, as such, if and when a vehicle is parked in a lot wherein there are no parking space transceiver units. Said vehicle upon its ignition being turned off or emergency brake being pulled off, transmits an RF coded signal 10 indicating its presence on a lot. Said lot base station transceiver unit 20 receiving said vehicle transceiver unit signal, and the base station computer 21 interface logs said particular vehicle 56 info into it's database. The base station computer 21 initiates random or at time interval RF coded signal 11 through said base station transceiver unit 20, to communicate with a particular motor vehicle 56 transceiver unit 23 to verify the presence of the particular vehicle on the lot. If more then 2 intervals of communication attempt by the base station computer 21 does not generate a successful link between the base station computer 21 and the vehicle transceiver unit 23, the computer indicates the departure of the particular vehicle 56 from its inventory system. If and when the base station computers 2 interval communication attempts cannot communicate with the particular vehicle transceiver unit 23, due to vehicle was removed from the lot without prior removal authorization data entry into the computer. The computer 21 will initiate an alarm signal.

In the present invention, the vehicle RF transceiver unit 23 optionally is equipped with an intrusion alarm. The base station is capable receiving any security violation RF signal 10 from a vehicle transceiver unit 23 parked on the lot, such as a intrusion alarm, unauthorized vehicle door been open, a shock sensor being triggered, unauthorized vehicle ignition is being turned on or vehicle voltage drop sensed due to a vehicle door being open, or ignition being turned on. In the present invention the base station computer 21 is capable of sending RF signal 11, to a particular vehicle unit 23, on a lot to Lock/unlock the doors, to flash the lights, to honk the horn and immobilize vehicle engine.

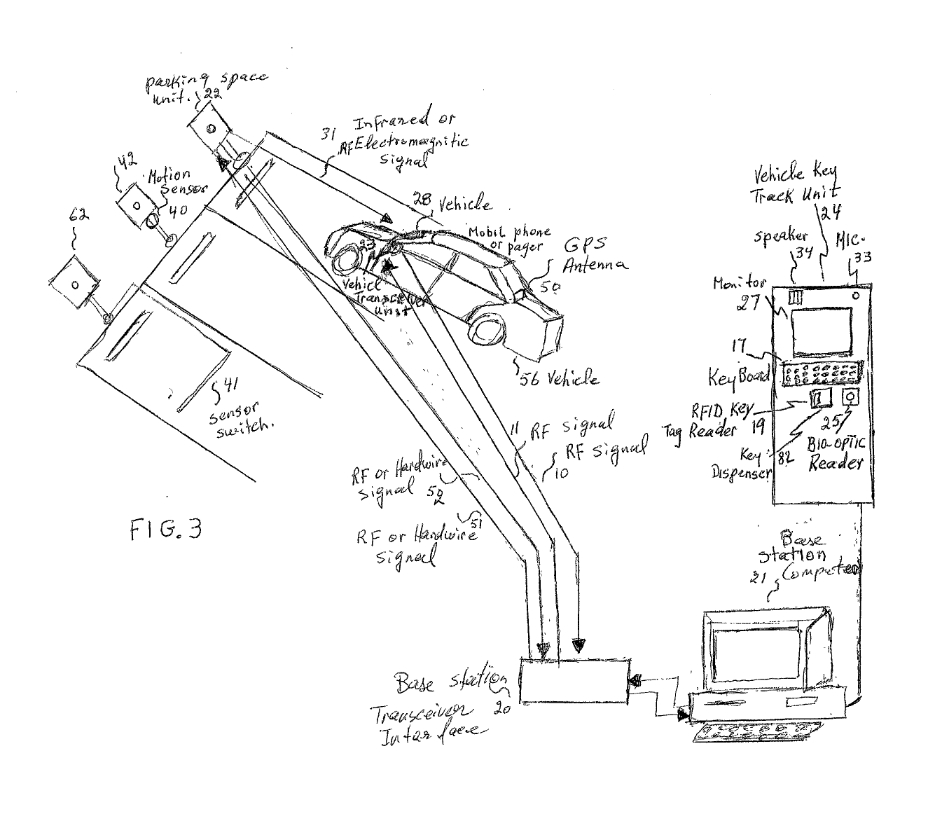

FIG. 3 Describes an Electronic Vehicle Monitoring system wherein a plurality of parking space transceivers units are installed at a particular parking space 22, 42, and 62. Parking space transceiver 22 is equipped with unidirectional Infrared or electromagnetic transmitter, and an RF low power transceiver. Parking space transceiver 42 additionally is equipped with a motion sensor 40. Parking space transceiver unit 62 is equipped with a pressure-sensing switch. A vehicle 56 is equipped with a vehicle transceiver unit 23, having a RF infrared or electromagnetic receiver and a low power RF transceiver. In addition the vehicle transceiver unit 23 is connected to a mobile phone/radio pager 28 with GPS antenna receiver unit 50. A base station transceiver 20 interfaced to a computer 21, which is connected to an electronic Key Track unit 24. The base station computer 21 communicates with said parking space units, vehicle transceiver units and Electronic Key Track unit 34.

A parking space unit 22 transmitting a unidirectional infrared or electromagnetic coded constant or time interval signal. And a vehicle 56 equipped with an infrared or electromagnetic receiver unit 23, receiving said signal 31, and transmitting said data with a low power RF signal 10, containing information to both to the parking space transceiver unit 22, and vehicle transceiver unit 23, to a base station computer transceiver interface. Which upon receipt of said signal logs in, the particular vehicle 56 and parking space 22 info into its memory and displays said information on its monitor. The base station computer 21 can update itself the presence or absence of a particular vehicle 56 at a particular parking space 22 by means of, sending coded signal to the particular vehicle transceiver unit 23 via base station transceiver 20. By signaling with an RF or hardwire random or time interval (scan) signal 51 to the parking space unit, and said parking space unit 22 retrieving data from said vehicle mount transceiver unit 23. The base station computer 21 also can retrieve data directly from the vehicle transceiver unit 23, by means of, the base station computer 21 sending random or time interval RF signal 11 to a particular vehicle transceiver unit 23 and said vehicle transceiver unit 23 upon receipt of said signal, sends an RF signal 10, containing information for both vehicle and parking space transceiver unit.

The invention utilizes an additional method for signaling a vehicle transceiver unit. Such as, the parking space transceiver 42 is connected to a motion sensor, when a vehicle 56 enters the particular parking space 42, the motion detector 40 senses the presence of the motor vehicle 56 and the parking space transceiver unit 42 transmits a directional infrared or electromagnetic signal to the vehicle transceiver unit 23. The invention also teaches another method of signaling a vehicle unit, which is illustrated in FIG. 3 where the parking space unit 62, is connected to a pressure-sensing switch 41, when a motor vehicle 56 enters the particular parking space 62, upon vehicle rolling over the pressure-sensing switch 41. the parking space transceiver unit 62, transmits a direction infrared or electromagnetic signal, to the vehicle transceiver unit 23.

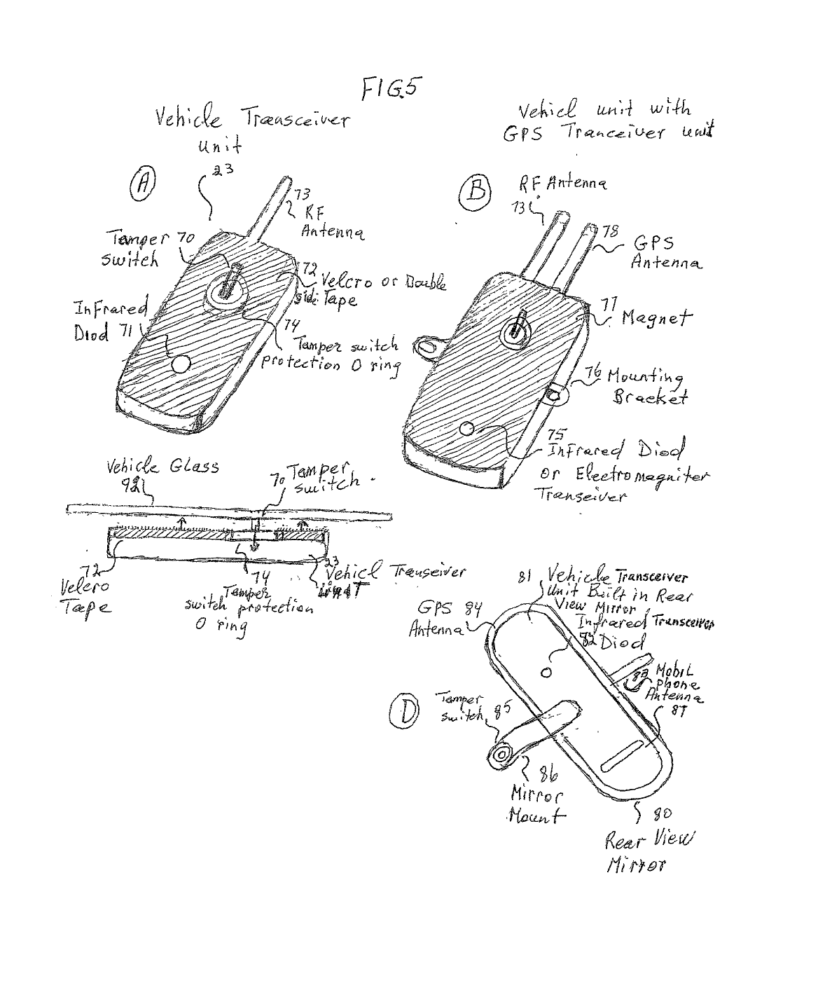

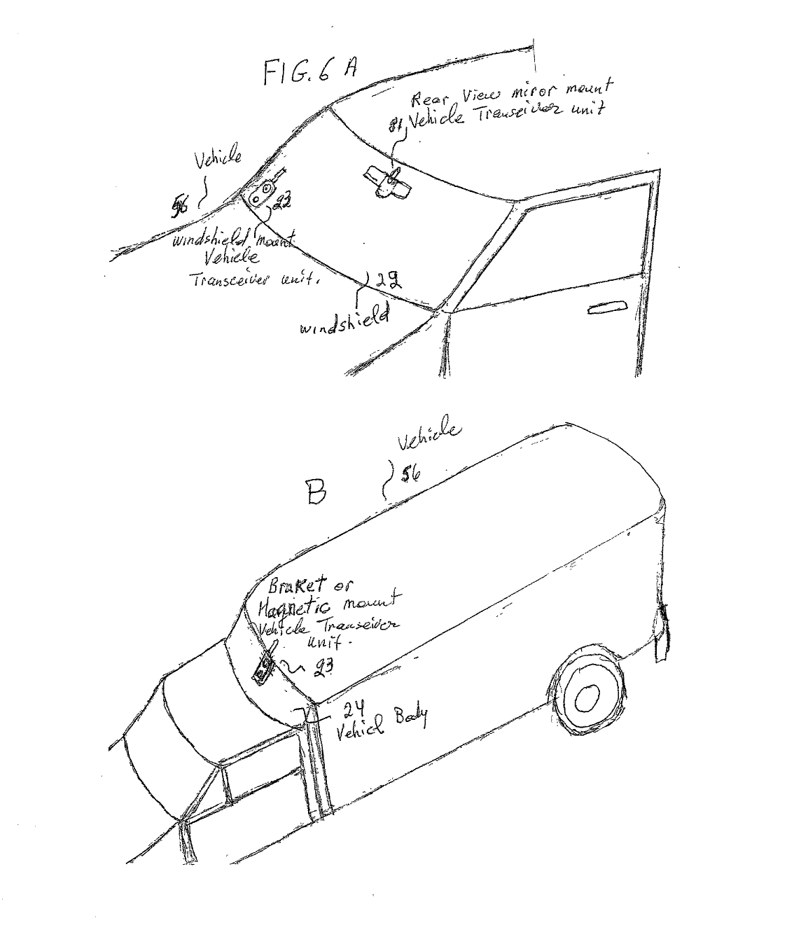

The Electronic Vehicle monitoring system of the present invention Additional to the use of RF transceiver unit 23, uses a GPS based 50 cellular phone or pager modem unit 28, for base station be able to communicate and locate the motor vehicle location. Especially when the motor vehicle(s) 56 to be monitored is out of particular parking space on the road. Where low power RF transceiver communication range becomes un Useful. The RF transceiver 23, GPS 50, mobile phone/pager modem unit 28, used in the invention are of tamper proof and each one of said units are equipped with a pressure sensing tamper switch 70 FIG. 5-A. And the tamper switch sensing side of the units are mounted against the vehicle windshield 22 FIG. 6-A, or mounted within rear view mirror 81 FIG. 6-A and or mounted against the vehicle body 24 FIG. 6-B. Said vehicle RF transceiver or GPS/phone units are communicating with an RF or hardwire signal with vehicle mount Immobilizer circuitry. If and when an attempt is been made to tamper or remove the vehicle mount RF transceiver 23 or GPS 50, mobile phone/pager modem 28, the vehicle will be immobilized, Such as Gradual fuel pump cut off, starter interrupt, Ignition Immobilization Etc.

The Electronic vehicle monitoring system in addition is capable of controlling an Electronic Key Track unit 24. Which is equipped with a Keybord 17 for user to select desired vehicle, a monitor 27 to indicate vehicle information and location on the lot, and a user Finger print Bio-optic reader 25, and RFID (transponder) key reader 19. When an authorized person put their finger on Key Track finger read bio-optic scanner 25 The bio-optic scanner upon reading persons valid (pre-programmed) fingerprint pattern. The Key Track unit displays on its monitor 27 for user to enter a selected vehicle ID number by use of keyboard 17. The Key Track unit 24 upon receipt of selected vehicle ID code dispenses the chosen vehicle key containing RFID tag. Said vehicle Key RFID Tag information is read by said Key Track RFID Key Tag reader 19, and said Key Track unit indicates a particular vehicle key being checked out from its inventory. And logs inn in the computer memory the person ID information, which who took a particular vehicle key at a particular site at a particular time. When the user dispenses back the vehicles key in the dispenser 82. The Key Track unit reads the key RFID information and logs back in it's inventory the presence of a particular vehicle key, and time stamps the key return event in it's memory.

Additionally the Key Track unit 34 is equipped with a microphone 33, a voice recognition processor and a speaker 34, used to give verbal instruction to the user. For user identification it utilizes user voice recognition technology. User gives its given password (pre-Recorded) through said microphone 33. Upon user voice recognition, The Key Track unit 24 allows the user to gets access into selecting to receive a vehicle key. In the preferred embodiment of the present invention, user gives verbal commends in said microphone 33, to select a particular vehicle and receive the particular vehicle key without the use of the keyboard.

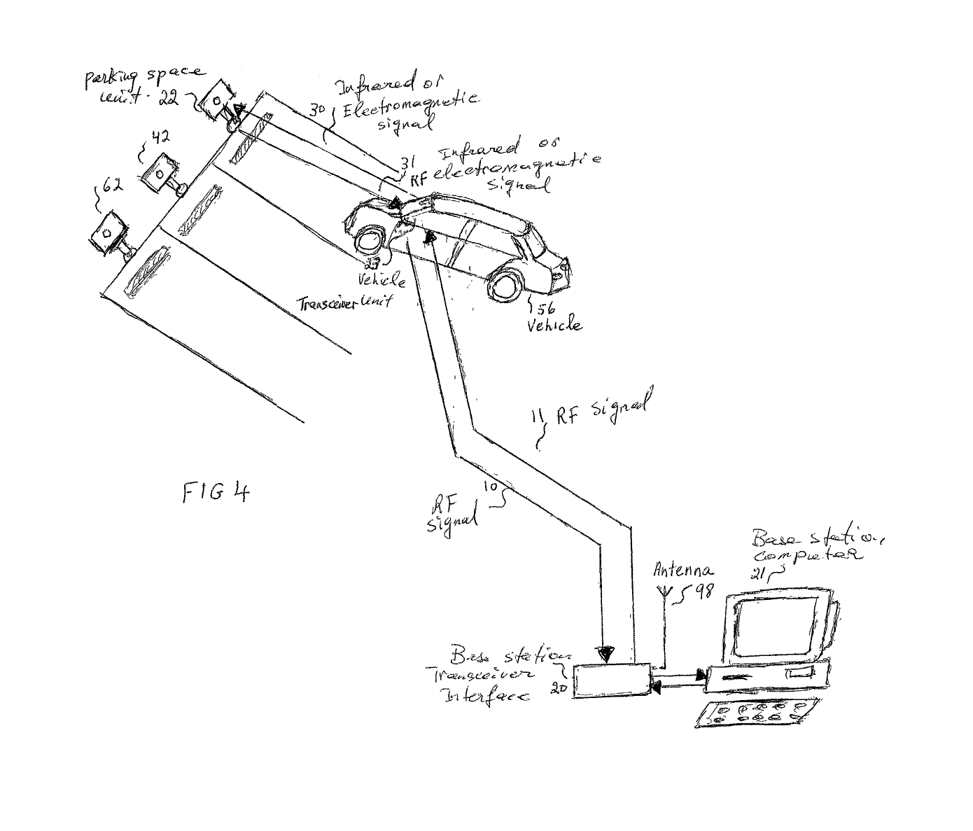

The invention also teaches another practical method of determining the presence of motor vehicle at a particular parking space on a lot. As illustrated in FIG. 4 there are plurality of parking space unit 22, 42, and 62. A vehicle 56 equipped with Directional Infrared or electromagnetic transceiver unit and an RF low power transceiver unit 23, and a base station transceiver unit 20 with an antenna 98, interfaced with a computer 21. A vehicle 56 entering a particular parking space 22, the particular vehicle transceiver unit 23 is transmitting a directional Infrared or electromagnetic signal. The parking space transceiver unit 22 receiving said signal and upon receipt is transmitting a unidirectional infrared or electromagnetic coded signal towards the vehicle transceiver unit. The vehicle transceiver unit 23, upon receipt of said signal, said vehicle transceiver unit 23 is transmitting a RF low power signal containing information to said parking space unit 22 and to said vehicle transceiver unit 23, to a base station transceiver unit which is receiving said signal using an antenna 98. Said base station transceiver 20 computer interface 21 unit upon receipt of said signal, logs in the presence of said vehicle 56 and the parking space 22 information in its database memory.

AS shown in FIG. 5-A the vehicle transceiver 23 of the present invention is tamper proof Having a pressure sensing tamper switch 70. Protected by a protection metal “O” ring 74 And is mounted against the vehicle windshield or on to the vehicle body, by use of Velcro or double sided tape 72. And has an infrared Diode 71, opening to communicate with parking space units. And has an antenna 73, to communicate with base station computer interface unit. As shown in FIG. 5-B the vehicle transceiver in addition has a built-in GPS receiver antenna 78, and instead of Velcro mounting tape the system utilizes a magnet 77, for mounting the unit against vehicle body. And the unit can be mounted by use of mounting bracket 76. In the as shown in FIG. 5-B the vehicle transceiver unit utilizing the electromagnetic transceiver 75. The transceiver, the GPS antenna and the mobile phone/pager unit utilized in the present invention could be implemented in a vehicle with highly undetectable by thieves. By incorporating into a rearview mirror as shown in FIG. 5-D

What is claimed:

1. Electronic Vehicle Monitoring System for tracking the location of a plurality of motor vehicles at a particular location having a plurality of parking slots thereat, said system comprising
A plurality of parking space unit each for placement at a particular parking slot each of said plurality of parking units comprising a receiver for receiving signal and a transmitter for transmitting signals.
A plurality of vehicle units each for installation into a particular motor vehicle, each of said plurality of vehicle units comprising, a vehicle unit transceiver for transmitting and receiving signals, said transceiver transmitting a unique low power signal to said parking space unit receiver, each of said plurality of parking space unit receiving a unique low power signal from a particular vehicle in which said vehicle units is installed in and is parked in a particular slot.
A computer interface transceiver unit installed in a base station which used to monitor the operation of said system.
Said parking space unit transmitter signaling to said base station transceiver unit and said base station transceiver receiving said signal.

2. Electronic Vehicle Monitoring System as defined in claim 1 wherein each of said plurality of vehicle units comprises
a processor, a memory containing unique information identifying the particular vehicle
a power supply
a receiver and
a low power RF transmitter. For transmitting a unique unindirectional signal from a particular vehicle unit, to a particular parking space receiver unit at the particular vehicle is parked in.

3. Electronic Vehicle Monitoring System as defined in claim 1 wherein each of said plurality of parking space units comprises
a processor
a power supply, a receiver, a transmitter
a memory containing unique information identifying the particular parking space.
A receiver for receiving unique low power RF signal from a particular vehicle unit installed in a particular vehicle. A transmitter transmitting an signal to a base station receiver unit containing information identifying the particular parking slot tat the particular motor vehicle is parked in.

4. Electronic Vehicle Monitoring System as defined in claim 1 wherein said base station comprises
a computer
a Transceiver unit
A computer interface for connecting said base station transceiver to a computer unit which used to monitor the operation of said system. Said computer transceiver receiving a signal from said parking space unit containing information identifying the particular parking slot that the particular motor vehicle is parked in.

5. Electronic Vehicle Monitoring System as claimed in claim 1 wherein said parking space unit transmitter transmitting a signal to a base station transceiver unit containing information identifying both the particular motor vehicle that said vehicle unit is installed in and the particular parking slot that the particular motor vehicle is parked in and a base station computer interface unit receiving information identifying both the particular motor vehicle that each vehicle unit is installed in and the particular parking slot that each motor vehicle is parked in.

6. Electronic Vehicle Monitoring System comprises a Vehicle unit Transceiver unit installed in plurality of motor vehicles containing unique information identifying the particular vehicle unit.
Said plurality of vehicle unit transmitter transmitting a unique RF containing information identifying a particular motor vehicle that said vehicle unit is installed in. And a base station computer interface unit receiving said information identifying the particular motor vehicle that each vehicle unit is installed in, from a set distance in a lot.

7. Electronic Vehicle Monitoring System as claimed in claim 1 & 6 wherein each of said plurality of vehicle unit transmitter transmitting said signal upon said vehicle ignition system is being turned off.

8. Electronic Vehicle Monitoring System as defined in claim 1 wherein said base station computer signaling said base station transceiver unit to transmit a unique RF coded signal to a particular vehicle unit, said particular vehicle unit upon receiving said signal transmits a RF signal containing vehicle information identifying said particular motor vehicle that said vehicle unit is installed in to said base station computer interface unit.

9. Electronic, Vehicle Motoring System as claimed in claim 1 & 6 wherein each of said plurality of motor vehicle unit transmitter transmitting upon said vehicle transceiver receiving a unique RF coded signal from said base station transceiver unit.

10. Electronic Vehicle Monitoring System as defined in claim 1 wherein said base station computer signaling said base station transceiver unit to transmit a unique coded signal to a particular parking space unit, said parking space unit upon receiving said signal, transmits said parking space information identifying said particular parking space unit installed in a particular parking slot to said base station computer interface unit.

11. Electronic Vehicle Monitoring System as claimed in 2 wherein each of said plurality of vehicle unit transmitting a infrared unindirectional signal.

12. Electronic Vehicle Monitoring System as claimed in claim 2 wherein each of said plurality of vehicle unit transmitting Electromagnetic signal.

13. Electronic Vehicle Monitor System as claimed in claim 3 wherein each of said plurality of parking space receiver unit receiving a infrared signal from particular vehicle unit.

14. Electronic Vehicle Monitoring System as claimed in claim 3 wherein each said plurality of parking space units receiving an electromagnetic signal from a particular vehicle unit.

15. Electronic Vehicle Monitoring System for tracking the location of plurality of motor vehicles at a particular location having a plurality of parking slots thereat, said system comprising.
A plurality of parking space unit each for placement at a particular parking slot, each of said plurality of parking units comprising receiver for receiving signal and a transmitter for transmitting signals.
A plurality of vehicle units each for installation into a particular motor vehicle each of said plurality of vehicle units comprising, a vehicle transceiver unit for transmitting and receiving signals.
Said parking space unit transmitting a unique low power signal to a particular vehicle unit parked at a particular parking slot. Said vehicle transceiver unit upon receiving said signal said vehicle transceiver transmits a unique RF signal containing said vehicle information to a base station computer interface unit.

16. Electronic Vehicle Monitoring System as claimed in claim 15 wherein said parking space unit transmitting a unique low power RF signal to a particular vehicle unit upon receiving a signal from said base station computer interface unit.

17. Electronic Vehicle Monitoring System as claimed in claim 15 wherein said vehicle unit transmitting a unique RF said containing both vehicle and parking space information to a base station computer interface unit

18. Electronic Vehicle Monitoring System as claimed in claim 15 wherein said base station computer interface unit signal a particular vehicle transceiver unit with a unique RF coded signal, said vehicle transceiver receiving said signal and said vehicle transceiver unit signaling with a unique low power RF signal a particular parking space unit that said particular vehicle is parked in said parking space unit upon receiving said signal from said particular motor vehicle unit, transmits a signal to said vehicle unit with a low power RF signal containing information to said particular parking space unit. said vehicle transceiver unit upon receiving signal from a particular parking space unit, said vehicle unit signaling said base station computer interface with a RF signal containing information both the particular motor vehicle unit that each of said vehicle units are installed in and the particular parking space unit that each motor vehicle is parked in.

19. Electronic Vehicle Monitoring System as claimed in claim 15 wherein said parking space unit is equipped with a motion sensor, said sensor signaling said upon detecting vehicle movement in a particular parking space unit is installed in, said sensor signaling said particular parking space unit to transmit a low power signal to said particular vehicle transceiver unit installed within said particular vehicle, and said vehicle transceiver unit upon receiving said signal from the particular parking space unit transmits a unique RF signal containing said vehicle information to a base station computer interface unit.

20. Electronic Vehicle Monitoring System as claimed in claim 15 wherein said plurality of parking space unit is connected to a sensor switch said switch is placed within plurality of parking space, said sensor switch detecting vehicle movement when a particular vehicle enters or exit said particular parking space by means of traveling over said sensor switch, said sensor signaling said particular parking space unit to transmit a low power signal to said particular vehicle transceiver unit installed in a particular vehicle. Said vehicle transceiver unit upon receiving said signal from said particular parking space unit transmits a unique RF signal containing information to said particular motor vehicle to a base station computer interface unit.

21. Electronic Vehicle Monitoring System as claimed in claim 15 wherein said parking space unit transmitting a unique directional inferred signal.

22. Electronic Vehicle Monitoring System as claimed in claim 15 wherein said parking space unit transmitting unique electromagnetic signal.

23. Electronic Vehicle Monitoring System as claimed in claim 15 wherein said vehicle transceiver unit receiving a unique infrared signal.

24. Electronic Vehicle Monitoring System as claimed in claim 15 wherein said vehicle transceiver unit receiving a unique electromagnetic signal.

25. Electronic Vehicle Monitoring System as claimed in claim 1-6 & 15 wherein said means for determining the presence of a security violation comprises at least one of the group consisting of a ignition switch sensor used to sense when the particular vehicle is started, a voltage drop circuitry to sense when a door or trunk is opened, a motion sensor used to detect motion in the particular vehicle and a door switch sensor used to sense when one of the particular vehicles door is opened, and transmitting means transmitting at least one of said group violation to said monitoring station.

26. Electronic Vehicle Monitoring System as claimed in claim 25 wherein said security violation comprises at least one of the group consisting of a light controller which may be used to flash the particular motor vehicle lights, one immobilizer module may be used to disable the particular motor vehicle engine. A horn controller which may be used to honk the horn. A auto dialer phone or a pager which is installed within said vehicle to signal a monitoring station. Presence of a violation.

27. Electronic Vehicle Monitoring System as claimed in claim 1-6 & 15 wherein said vehicle additionally is equipped with a GPS antenna and said base station is equipped with a GPS tracing system to monitor the location of said vehicle.

28. Electronic Vehicle Monitoring System as claimed in claim 1-6 & 15 wherein said base station computer is interfaced with a vehicle key track unit, said base station computer is capable of monitoring said key track system by means of which vehicle key is in or out from the key track system, and identifying the person in which had or has access to said keys.

29. Electronic Vehicle Monitoring System as claimed in claim 1-6 & 15 wherein said monitoring station is additionally equipped with a voice or digital auto dialer to notify a vehicle security violation to a monitoring station.

30. Electronic Vehicle Monitoring System as claimed in claim 1-6 & 15 wherein said monitoring station computer transceiver interface unit is capable of signaling a plurality of vehicle receiver unit, an RF signal to unit and or disarm said vehicle units.

31. Electronic Vehicle Monitoring System as claimed in claim 1-6 & 15 wherein said monitoring station computer transceiver is capable of signaling a plurality of vehicle receiver units, a unique RF signal to lock and or to unlock said vehicles doors.

32. Electronic Vehicle Monitoring System as claimed in claim 1-6 & 15 wherein said monitoring station computer transceiver unit capable of signaling a plurality of vehicle receiver units a unique RF signal to flash the lights and or honk the horn of said vehicle.

33. Electronic Vehicle Monitoring System as claimed in claim 1-6 & 15 wherein said monitoring station computer transceiver unit is capable of signaling a plurality of vehicle receiver units a unique RF sign to immobilize said vehicle engine.

34. Electronic Vehicle Monitoring System as claimed in claim 1-6 & 15 wherein said monitoring station comprises a hand held computer interface with a RF transceiver which may be used to monitor the operation of said system.

35. Electronic Vehicle Monitoring System as claimed in claim 26-27 wherein said vehicle transceiver and or GPS unit controlling the vehicle ignition system. If and when said vehicle transceiver and or GPS unit has been tampered with or disconnected from said vehicle, said vehicle transceiver and or GPS unit transmitting a signal to said vehicle ignition circuitry to immobilize said engine, and or honk the horn of said vehicle, and or signal a monitoring station the presents of a security violation.

36. Electronic Vehicle Monitoring system as claimed in claim 35, wherein said vehicle transceiver and or GPS unit communicating with said vehicle ignition circuitry by means of RF or hard wire signal.

37. Electronic Vehicle Monitoring system as claimed in claim 35, wherein said vehicle transceiver unit additionally comprises
a transceiver unit with a tamper switch
a mounting tape, a magnet, or a mounting bracket used to mount said vehicle unit into said vehicle
Said transceiver unit tamper switch location side is mounted against said vehicle structure, to control the operation of said vehicle unit. When said vehicle transceiver unit is removed from said mounted position, said vehicle transceiver unit transmitting a security violation signal.

38. Electronic Vehicle Monitoring System as claimed in claim 37, wherein said vehicle unit additionally comprises of a GPS antenna driver and or a mobile phone or a pager unit.

39. Electronic Vehicle Monitoring System as claimed in claim 37-38, wherein said vehicle unit is mounted within or onto said vehicle rear view mirror

40. Electronic Vehicle Monitoring System as claimed in claim 37, wherein said tamper switch additionally comprises of conductive rubber adhesive, used to mount said vehicle unit into said vehicle.

41. Electronic Vehicle Monitoring System as claimed in claim 28, wherein said vehicle key track (Key Dispenser) unit is equipped with a bio-optic finger print reader, to identify authorized user print, allowing user access to a selected vehicle key and log in said data.

42. Electronic vehicle Monitoring System as claimed in claim 41, wherein each one of said vehicle keys contain or is connected to a RFID tag. Each one of said Key Track unit is equipped with a RFID tag reader capable of log in and log out selected vehicle key given to a particular user.

43. Electronic Vehicle Monitoring System as claimed in claim 28, wherein said Key Track unit is equipped with a microphone, a voice recognition processor, for user identification. It utilizes user voice recognition process to dispose a particular vehicle key.

44. Electronic Vehicle Monitoring System as claimed in claim 41 wherein said user access to a selected vehicle is achieved by user given verbal command.

45. Electronic vehicle Monitoring System as claimed in claim 41, wherein said Key Track unit is equipped with a speaker to give verbal instruction to the user.

46. Electronic Vehicle Monitoring system as claimed in claim 35, wherein said vehicle transceiver CPU and GPS receiver units tempering or disconnecting, causes said vehicle fuel pump or starter circuit interrupts.
